(19) United States
(12) Patent Application Publication
(10) Pub. No.: US 2005/0075205 A1
(43) Pub. Date: Apr. 7, 2005

(54) Compact transmission device for a gym bicycle

(76) Inventor: Chih-Liang Chen, Taoyuan Hsien (TW)

Correspondence Address: BACON & THOMAS, PLLC, 625 SLATERS LANE, FOURTH FLOOR, ALEXANDRIA, VA, 22314, US

(21) Appl. No.: 10/677,231

(22) Filed: Oct. 3, 2003

(51) Int. Cl. F16H 7/12; F16H 7/14

(52) U.S. Cl. 474/116; 474/133; 474/119

(57) ABSTRACT

A transmission device for a gym bicycle has a base with three axles parallel to each other. A first driving wheel is mounted on the first axle and rotatable along with the first axle. A driven wheel is rotatably mounted on the second axle by a first bearing and connected with the first driving wheel by a first belt. A second driving wheel is rotatably mounted on the second axle by another first bearing and mounted on the driven wheel by a one-direction bearing. A flywheel rotatably is mounted on the third axle by two second bearings and connected with the second driving wheel by a second belt. Whereby, the transmission device can be adjusted before it is assembled on a frame.

### BACKGROUND OF THE INVENTION

1. Field of the Invention

The present invention relates to a gym bicycle, and more particularly to a transmission device for the gym bicycle which is easy to be assembled and adjusted.

2. Description of Related Art

Conventional gym bicycles generally have a driving wheel driven by a pair of pedal cranks and a flywheel connected with the driving wheel by a belt or chain. The driving wheel and the flywheel are individually mounted on a frame. In assembling, a tension of the belt or chain and/or a parallelism between axles of the driving wheel and the flywheel need to be adjusted. In the prior art, these adjustments are processed after the transmission structure including the driving wheel, the flywheel and their axles etc. is installed on the frame. Therefore, it is very inconvenient to process these adjustments on the frame. For example, if the frame is placed on the ground, an operator must squat to adjust the elements; and if the frame is placed on a worktable, the operator must lift the frame before performing the adjustments and put down the frame after the adjustments. Furthermore, during adjusting process, the operator often has to move between two ends or two sides of the frame, which is a very time-consuming process.

Therefore, the invention provides a transmission device for a gym bicycle to mitigate or obviate the aforementioned problems.

### SUMMARY OF THE INTENTION

The main objective of the present invention is to provide a transmission device for a gym bicycle which has a compact structure and can be adjusted before being assembled on a frame of the gym bicycle.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a transmission device in accordance with the invention;

FIG. 2 is an exploded perspective view of FIG. 1;

FIG. 3 is a perspective view of an interior structure of the transmission device in FIG. 1;

FIG. 4 is a side plan view of FIG. 3;

FIG. 5 is a cross sectional view of FIG. 4 taken along the line “5-5”; and

FIG. 6 is a schematic view of a gym bicycle assembled with the transmission device of the invention.

### DETAILED DESCRIPTION OF THE PREFERRED EMBODIMENT

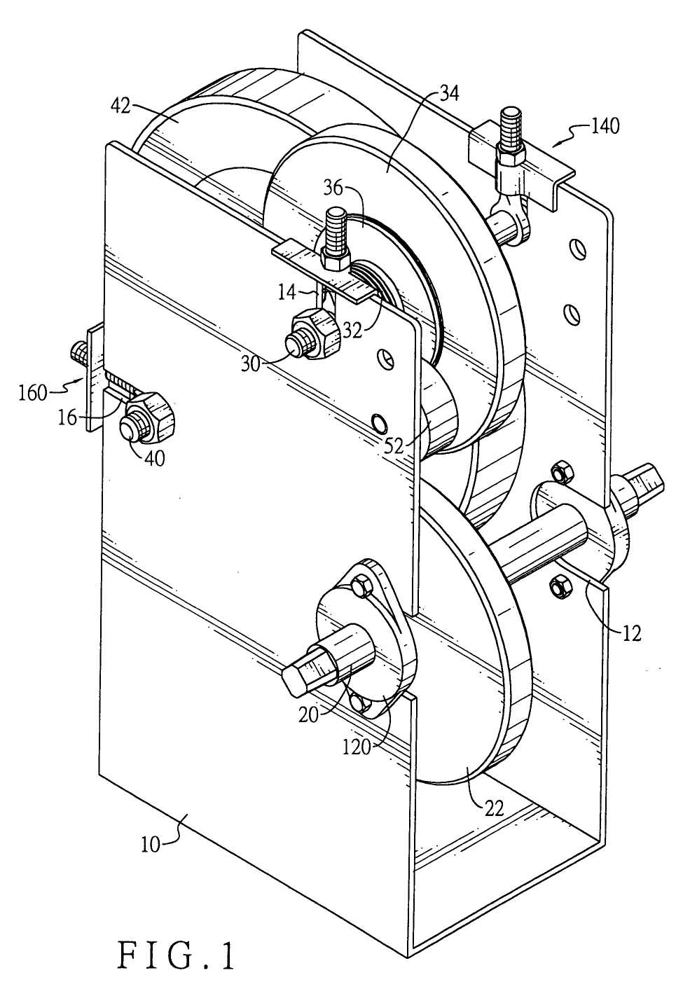

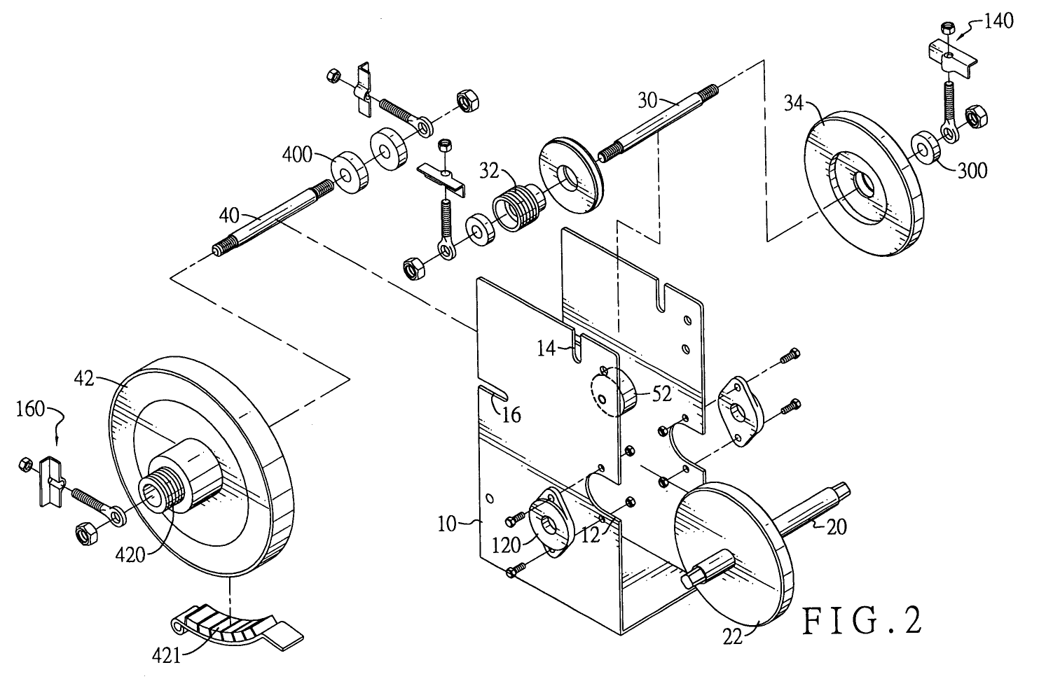

With reference to FIGS. 1-2, the transmission device for a gym bicycle in accordance with the invention has a U-like base (10) formed with a bottom plate (not numbered) and two upright plates (not numbered) perpendicular to the bottom plate. Each of the upright plates (10) has a top edge, a rear edge and a front edge.

A pair of first notches (12) is defined through the upright plates at the rear edges, a pair of second notches (14) is defined through the upright plates at the top edges, and a pair of third notches (16) is defined through the upright plates at the front edges.

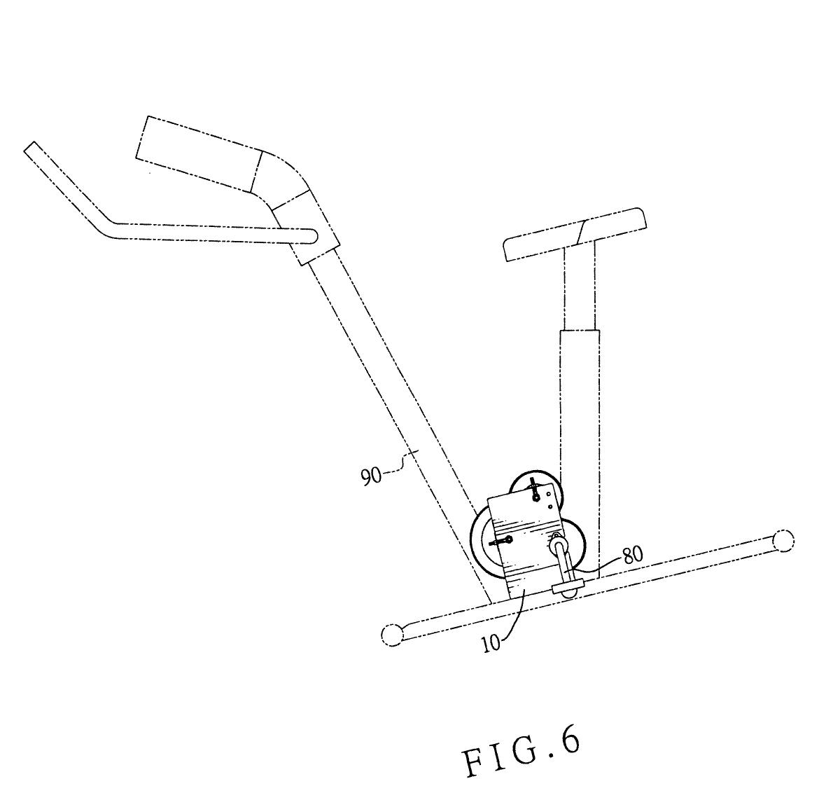

A first axle (20) is rotatably mounted in the first notches (12) by a pair of bearing seats (120) respectively fastened at exterior surfaces of the upright plates of the base (10). A first driving wheel (22) is mounted on the first axle (20) and rotatable along with the first axle (20). A pair of pedal cranks (80) can be assembled at two ends of the first axle (20), as shown in FIG. 6.

Referring back to FIGS. 1-2, a second axle (30) is mounted in the second notches (14) by a pair of vertical adjusting members (140) respectively fastened at the exterior surfaces of the upright plates of the base (10). The second axle (30) is parallel to the first axle (20). A driven wheel (32) and a second driving wheel (34) are rotatably mounted on the second axle (30) by first bearings (300), and the second driving wheel (34) is mounted on the driven wheel (32) by a one-direction bearing (36).

A third axle (40) is mounted in the third notches (16) by a pair of horizontal adjusting members (160) respectively fastened at the exterior surfaces of the upright plates of the base (10). The third axle (40) is parallel to the first and second axles (20, 30). A flywheel (42) is rotatably mounted on the third axle (40) by two second bearings (400), and has a driven tubular part (420) aligned with the second driving wheel (34). A magnetic damper (421) is mounted outside the flywheel (42) to increase a resistance to rotate.

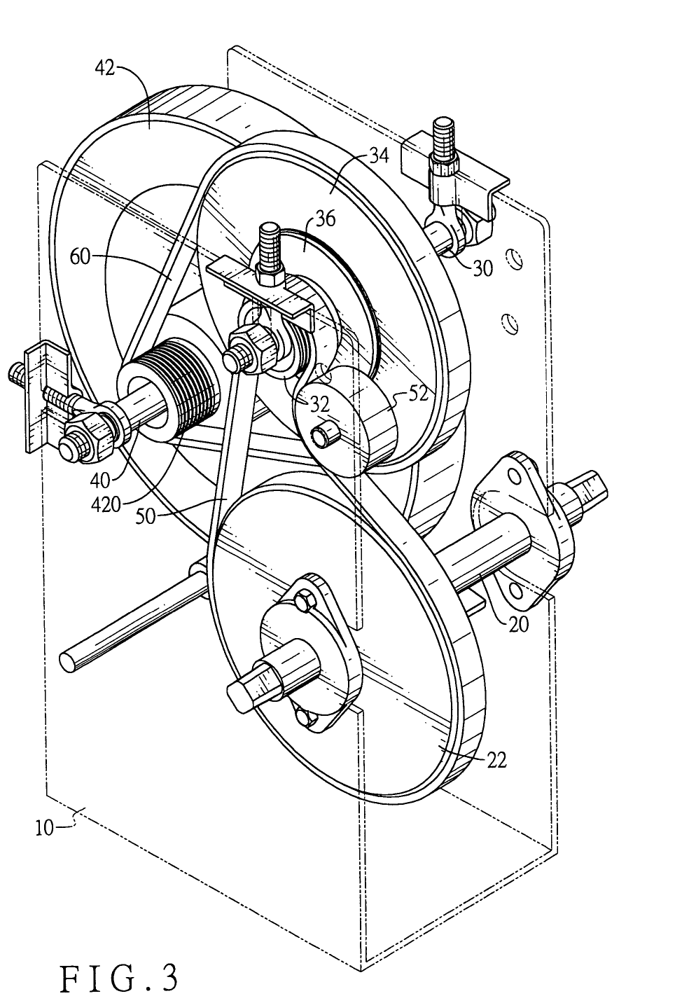

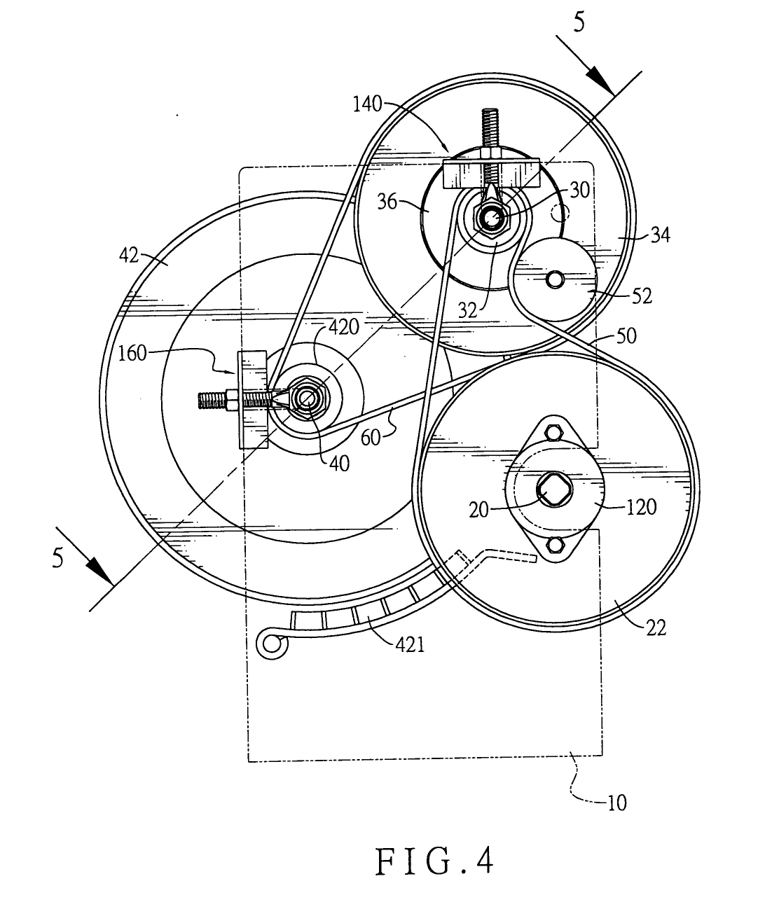

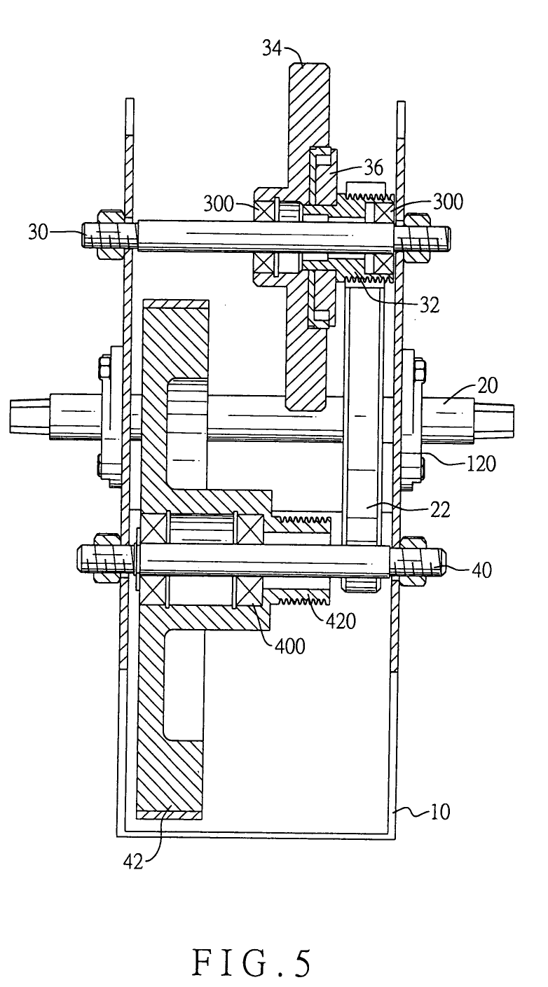

With reference to FIGS. 3-5, the first driving wheel (22) is connected with the driven wheel (32) by a first belt (50). An idler wheel (52) is rotatably mounted outside the first belt (50) and presses against the first belt (50) to tightly abut the first belt (50) to the driven wheel (32). The second driving wheel (34) is connected with the driven tubular part (420) of the flywheel (42) by a second belt (60).

With further reference to FIG. 6, when a user drives the first axle (20) by the cranks (80), the first driving wheel (22) is rotated to drive the driven wheel (32) by the first belt (50). The driven wheel (32) drives the second driving wheel (34) to rotate by the one-direction bearing (36). Then, the flywheel (42) is driven to rotate by the second belt (60).

When the user stops pedaling or pedals reversedly, the second driving wheel (34) will not be driven by the reversed rotation of the driven wheel (32) because of the one-directional bearing (36), and can freely rotate. The one-directional bearing (36) is provided between the driven wheel (32) and the second driving wheel (34) on the second axle (30), so that the one-direction bearing (36) does not have a rotation speed as fast as the flywheel (42) on the third axle (40), and does not have a torque as large as the driving wheel (22) on the first axle (20). Therefore, the one-direction bearing (36) has a long use life and the noise of the transmission device during pedaling is low.

According to the present invention, the transmission components are installed in the base (10) and can be previously adjusted by the idler wheel (52) and the adjusting members before the transmission device is assembled on a frame (90) of the gym bicycle, as shown in FIG. 6. Thus, the transmission device has a very compact structure, which is very easy and convenient to assemble the gym bicycle.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A transmission device for a gym bicycle comprising:
a base;
a first axle rotatably installed in the base;
a first driving wheel mounted on the first axle and rotatable along with the first axle;
a second axle installed in the base and parallel to the first axle;
a driven wheel rotatably mounted on the second axle by a first bearing and connected with the first driving wheel by a first belt;
a second driving wheel rotatably mounted on the second axle by a bearing and mounted on the driven wheel by a one-direction bearing;
a third axle installed in the base and parallel to the first and second axles; and
a flywheel rotatably mounted on the third axle by two second bearings and connected with the second driving wheel by a second belt.

2. The transmission device as claimed in claim 1, wherein the base has a U-like shape constructed by a bottom plate and two upright plates, each upright plate with a topedge, a rear edge and a front edge, the upright plates have a pair of first notches defined therethrough at the rear edges, a pair of second notches defined therethrough at the topedges, and a pair of third notches defined therethrough at the front edges, the first axle is installed in the first notches by a pair of bearing seats, the second axle is installed in the second notches by a pair of vertical adjusting members, and the third axle is installed in the third notches by a pair of horizontal adjusting members.

3. The transmission device as claimed in claim 1, wherein the flywheel has a driven tubular part extending from a center thereof and connected with the second driving wheel by the second belt.

4. The transmission device as claimed in claim 1 further comprising an idler wheel rotatably mounted outside the first belt and pressing against the first belt to tightly abut the first belt to the driven wheel.

5. The transmission device as claimed in claim 1 further comprising a magnetic damper installed outside the flywheel.
